(19) United States
(12) Patent Application Publication
(10) Pub. No.: US 2026/0033914 A1
(43) Pub. Date: Feb. 5, 2026

(54) DENTAL SCALING INSTRUMENT AND METHOD FOR MANUFACTURE

(71) Applicant: Young Innovations, Inc., Algonquin, IL (US)

(72) Inventor: Thomas STIERNS, Missoula, MT (US)

(21) Appl. No.: 19/284,517

(22) Filed: Jul. 29, 2025

Related U.S. Application Data
(60) Provisional application No. 63/677,111, filed on Jul. 30, 2024.

(51) Int. Cl. A61C 3/00

(52) U.S. Cl. CPC A61C 3/00

(57) ABSTRACT

A dental scaling instrument comprising a handle segment and a curved segment mechanically connected to the handle segment. The curved segment comprises a support portion configured to connect the handle segment with the curved segment and a blade mechanically connected to the support portion, where the blade further comprises a depressed top face comprising a depression, at least two side faces wherein each of the at least two side faces are disposed adjacent to the top face sharing an edge, a bottom face contiguous with each of the at least two side faces and a distal tip formed by an intersection of the depressed top face, the at least two side faces, and the bottom face, wherein a bevel angle of the edge between the depressed top face and each of the at least two side faces is in a range of 20° to 75°.

### CROSS-REFERENCE TO RELATED APPLICATIONS

This application claims the benefit of, and priority to, U.S. Provisional Application No. 63/677,111, filed on Jul. 30, 2024, the disclosures of which are incorporated by reference herein in their entirety.

### TECHNICAL FIELD

The present disclosure relates to a dental scaling instrument, and more specifically to a geometrically impressed groove on the top surface of the dental scaling instrument for a sharpened edge and the method of manufacturing said dental scaling instrument.

### BACKGROUND

Dental scaling instruments are essential tools used by dental professionals to remove dental calculus (tartar) from teeth surfaces. If not adequately managed, calculus buildup can lead to various oral health issues, including gum disease and tooth decay. The effectiveness of these instruments relies heavily on their design, particularly the bevel angle of the blade, which influences both the force required for calculus removal and the frequency of sharpening needed to maintain their efficiency.

Traditionally, dental scaling instruments are manufactured with a focus on maintaining a sharp edge that can effectively remove calculus with minimal effort. However, existing designs often require significant force from the user, which can lead to hand fatigue and decreased efficiency over time. Further, these instruments require frequent sharpening to retain their effectiveness, which increases maintenance time and cost for dental practices.

In conventional dental scaling instruments, the top face is typically left untouched during the sharpening process. This design approach focuses on removing material from the side face to adjust the bevel angle. However, this method has limitations, as it does not optimize the edge angle effectively, often resulting in instruments that require more force for calculus removal and frequent sharpening.

The present disclosure addresses these challenges by introducing a new blade geometry that modifies the top face of the dental scaling instrument. By changing the angle of the top face during the formation, the reduced bevel angle decreases the necessary force to remove dental calculus and the frequency of sharpening the instrument. This innovative approach not only enhances the efficiency of the instrument but also maintains its strength, ensuring durability and reliability in clinical use.

The present disclosure is supported by studies showing that the edge angle has a significant impact on retaining a sharp edge over time. By optimizing the bevel angle through a novel manufacturing process, the present disclosure provides a more effective and durable solution for dental professionals, ultimately improving patient care and operational efficiency in dental practices.

### SUMMARY

Disclosed herein are approaches for addressing various of the problems and shortcomings of the state of the art, as identified above. More particularly, disclosed herein are a geometrically impressed groove on the top surface of the dental scaling instrument for a sharpened edge and the method of manufacturing said dental scaling instrument.

According to a first aspect of the present disclosure, there is provided a dental scaling instrument comprising a handle segment and a curved segment mechanically connected to the handle segment. The curved segment comprises a support portion configured to connect the handle segment with the curved segment and a blade mechanically connected to the support portion, where the blade further comprises a depressed top face comprising a depression, at least two side faces wherein each of the at least two side faces are disposed adjacent to the top face sharing an edge, a bottom face contiguous with each of the at least two side faces and a distal tip formed by an intersection of the depressed top face, the at least two side faces, and the bottom face, wherein a bevel angle of the edge between the depressed top face and each of the at least two side faces is in a range of 20° to 60°.

According to a second aspect of the present disclosure, there is provided a method for manufacturing a dental scaling instrument, the method comprising the steps of loading a dental scaling instrument with a pre-die pressed blade onto a die-pressing system comprising a top die and a bottom die, wherein the pre-die pressed blade comprises a top face and a bottom face, die pressing the pre-die pressed blade with the die-pressing system to create a depression in the top face of the pre-die pressed blade to output a die-pressed un-sharpened blade comprising a depressed top face and a bottom face, and sharpening the die-pressed pre sharpened blade to output a blade comprising a depressed top face comprising a depression, at least two side faces where each of the at least two side faces are disposed adjacent to the top face sharing an edge, a bottom face contiguous with each of the at least two side faces, and a distal tip formed by an intersection of the depressed top face, the at least two side faces, and the bottom face, where a bevel angle of the edge between the depressed top face and each of the at least two side faces is in a range of 20° to 75°.

### BRIEF DESCRIPTION OF THE DRAWINGS

The drawing figures depict one or more implementations in accord with the present teachings, by way of example only, not by way of limitation.

FIG. 1 shows a side view of an exemplary aspect of a dental scaling instrument as described in this specification.

FIG. 2A shows a perspective view of an exemplary implementation of a blade of a previous iteration of the dental scaling instrument as described in this specification.

FIG. 2B shows a cross-sectional drawing of the exemplary implementation of the blade of the previous iteration of the dental scaling instrument as described in this specification.

FIG. 2C shows a schematic of an exemplary sharpening process of the exemplary blade of FIGS. 2A and 2B.

FIG. 3A shows a perspective view of an exemplary implementation of a blade of a current iteration of the dental scaling instrument as described in this specification.

FIG. 3B shows a cross-sectional drawing of the exemplary implementation of the blade of the current iteration of the dental scaling instrument as described in this specification.

FIG. 3C shows a schematic of an exemplary die pressing process of the exemplary blade of FIGS. 3A and 3B.

FIG. 3D shows a schematic of an exemplary sharpening process of the exemplary blade of FIGS. 3A and 3B.

FIG. 3E shows a cross-sectional drawing of the exemplary implementation of the blade of the current iteration of the dental scaling instrument with a single-sharpened side as described in this specification.

FIG. 4A shows a side view of an exemplary implementation of an edge with a bevel angle of 20° of the blade as described in this specification.

FIG. 4B shows a side view of an exemplary implementation of an edge with a bevel angle of 34° of the blade as described in this specification.

FIG. 4C shows a side view of an exemplary implementation of an edge with a bevel angle of 50° of the blade as described in this specification.

FIG. 5A shows an exemplary micrograph image of the edge of FIG. 4A post wear.

FIG. 5B shows an exemplary micrograph image of the edge of FIG. 4B post wear.

FIG. 5C shows an exemplary micrograph image of the edge of FIG. 4C post wear.

FIG. 6A shows an exemplary line graph of cut length against the number of cuts for bevel angles of 20°, 34°, and 50°.

FIG. 6B shows an exemplary bar graph of relative contribution to edge retention against factors affecting edge retention.

### DETAILED DESCRIPTION

While this disclosure includes a number of details and implementations in many different forms, there is shown in the drawings and will herein be described in detail particular implementations with the understanding that the present disclosure is to be considered as an exemplification of the principles of the disclosed methods and systems and is not intended to limit the broad aspects of the disclosed concepts to the implementations illustrated.

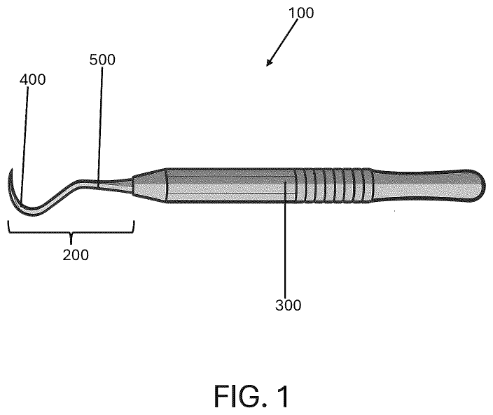

Referring to the drawings, FIG. 1 shows an exemplary aspect of a dental scaling instrument 100 as described in this specification. FIG. 1 also presents the primary structural components of the dental scaling instrument 100. These include a curved segment 200 and a handle segment 300 mechanically connected to each other. In this aspect of the dental scaling instrument 100, the curved segment 200 further comprises a blade 400 mechanically connected to a support portion 500. In this aspect, the handle 300 is connected to the curved segment 200 via the support portion 500. In some aspects of the dental scaling instrument 100, the handle segment 300 can be connected to the support portion 500 via metal welding. In some aspects, the handle segment 300 and support portion 500 may be connected by other methods, such as press/interference fit, adhesives, and induction heating. In other aspects, the handle segment 300 and curved segment 200 can be machined from a single metal piece via machining. In other embodiments, curved segment 200 can comprise a threaded extension configured to thread into a complementary threaded receiver disposed on the handle segment 300. In some aspects, the handle segment 300 and the curved segment can be made of a metal or metal alloy selected from a group including stainless steel and titanium. In some aspects, the handle 300 and the curved segment 200 can be made of different materials from each other.

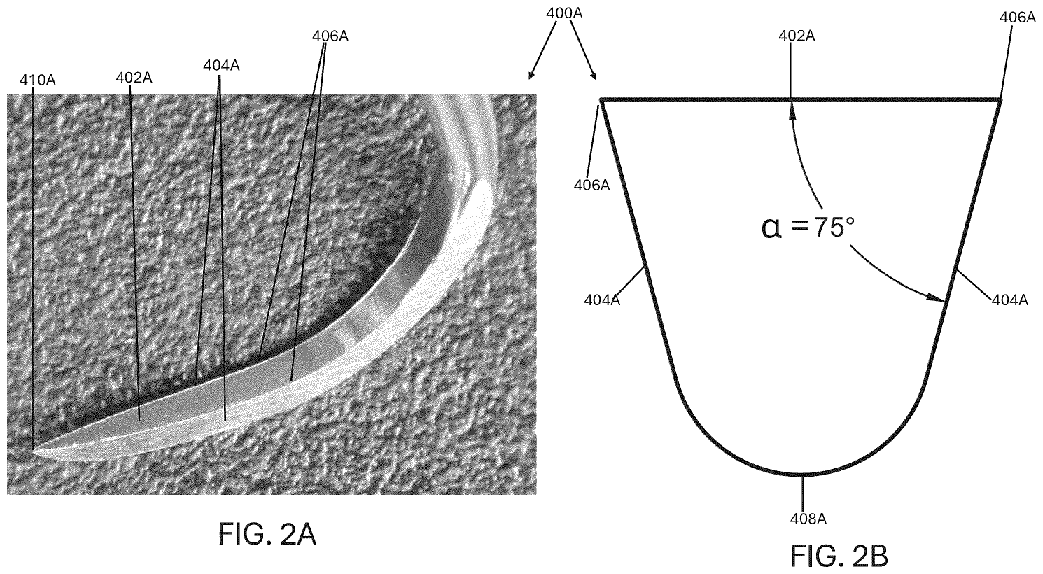

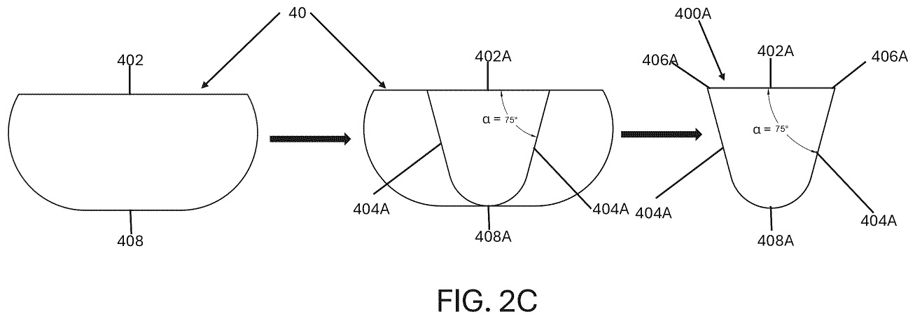

Referring to the drawings, FIGS. 2A and 2B show a perspective view and a cross-sectional view of an exemplary implementation of the blade 400A of a previous iteration of the dental scaling instrument 100. In this implementation of the blade 400A as shown in FIGS. 2A and 2B, the blade 400A comprises a top face 402A, at least two side faces 404A where each of the at least two side faces 404A are disposed adjacent to the top face 402A sharing an edge 406A, a bottom face 408A contiguous with each of the at least two side faces 404A, and a distal tip 410A formed by the intersection of the top face 402, the at least two side faces 404, and the bottom face 408. A bevel angle α of the edge 406A can be measured between the top face 402A and the adjacent one of the at least two side faces 404A. In this implementation of the blade 400A, the bevel angle α is 75°. In this implementation, the bevel angle α is impacted solely by the sharpening process (described in FIG. 2C) of the at least two side faces 404A.

Referring to FIG. 2C, a schematic of an exemplary sharpening process of the exemplary blade 400A of FIGS. 2A and 2B is shown. In this exemplary sharpening process, an un-sharpened blade 40 with a top face 402 and a bottom face 408 is subject to sharpening to form the blade 400A with the top face 402A, the bottom face 408A, the at least two side faces 404A and at least two edges 406A. In this implementation, the sharpening process achieves a bevel angle α of 75°. In this implementation of the sharpening process, the top face 402 of the un-sharpened blade 40 remains untouched during the sharpening process because of the challenge of manipulating the un-sharpened blade 40 to shape the top face 402 with an angle. In this implementation, the bevel angle α can be altered by further removing more material from at least two side faces 404A of the blade 400A. This implementation of the sharpening process does not optimize the bevel angle α sufficiently to reduce the force required for dental calculus removal or extend the time period of the blade 400A before it requires sharpening.

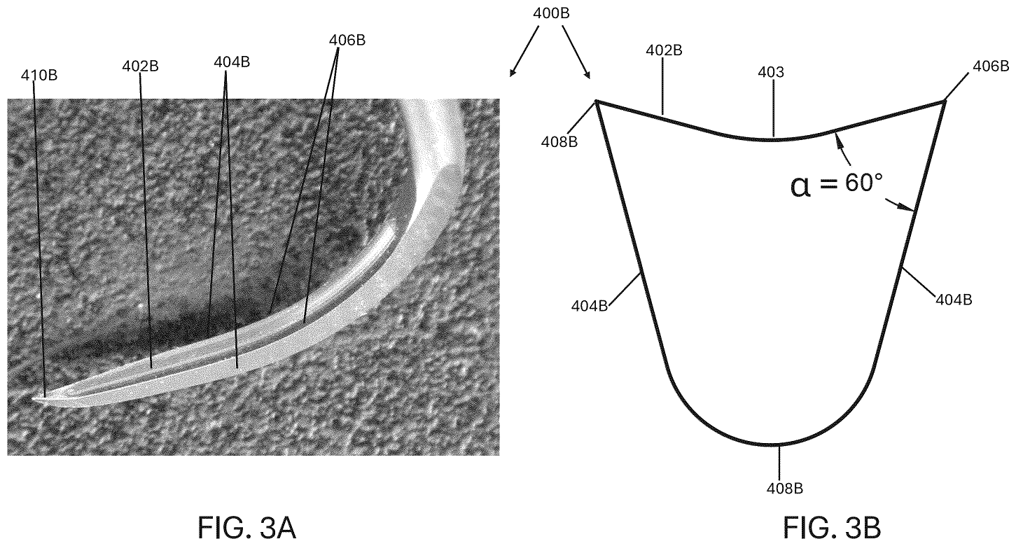

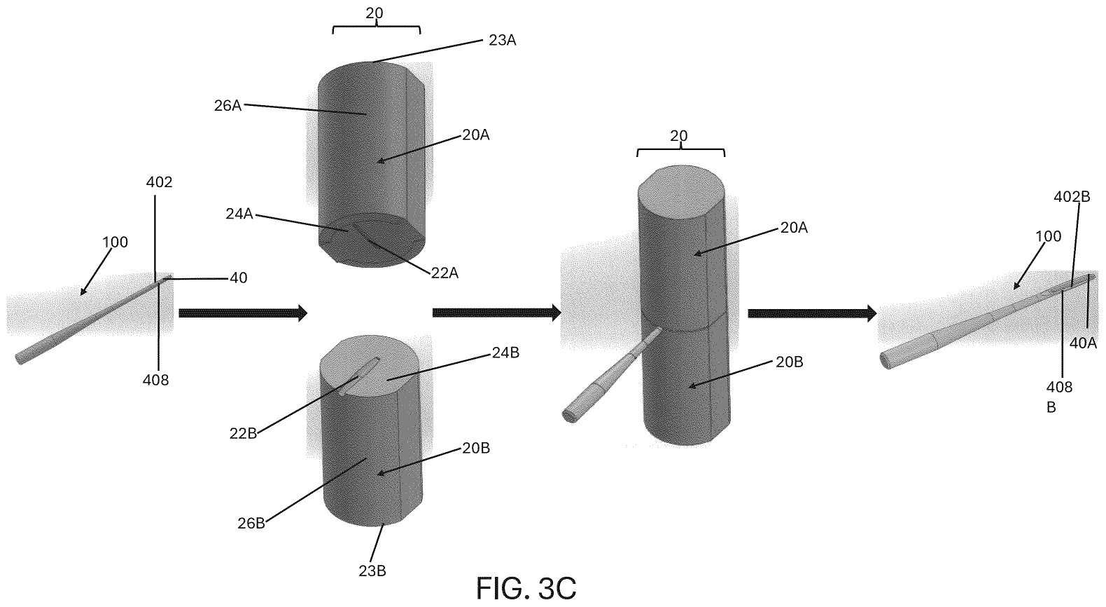

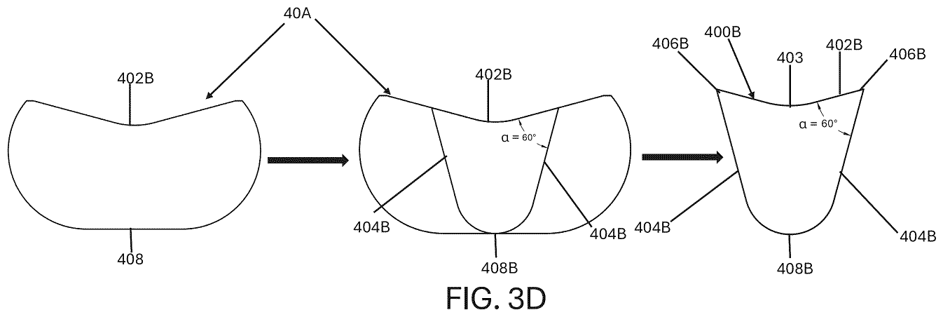

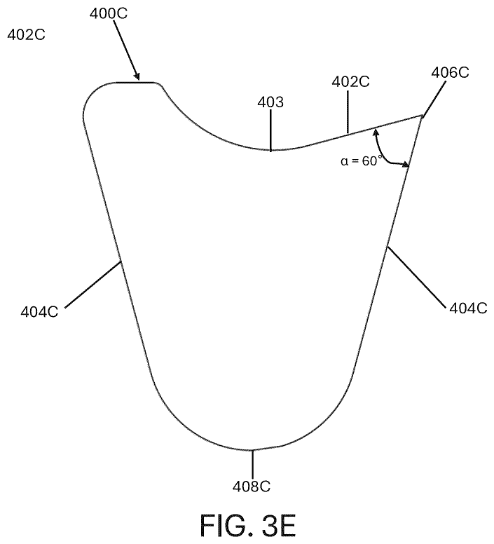

Referring to the drawings, FIGS. 3A and 3B show a perspective view and a cross-sectional view of an exemplary implementation of the blade 400 of a current iteration of the dental scaling instrument 100. In this implementation of the blade 400B as shown in FIGS. 3A and 3B, the blade 400B comprises a depressed top face 402B comprising a depression 403, at least two side faces 404B where each of the at least two side faces 404B are disposed adjacent to the depressed top face 402B sharing an edge 406B, a bottom face 408B contiguous with each of at least two side faces 404B, and a distal tip 410B formed by the intersection of the depressed top face 402B, the at least two side faces 404B, and the bottom face 408B. In some implementations, the distal tip 410B could be rounded. A bevel angle α of the edge 406B can be measured between the depressed top face 402B and the adjacent one of the at least two side faces 404B. In some implementations of the blade 400B, the bevel angle α can be in a range of 20° to 75°. In this implementation of the blade 400B, the bevel angle α is 60°. In this implementation, the bevel angle α is impacted by a combination of the die pressing process (described in FIG. 3C) affecting the shape of the top face 402B and the sharpening process (described in FIG. 3D) of the at least two side faces 404A.

Referring to FIG. 3C, a schematic of the exemplary die pressing process of the blade 400B of FIGS. 3A and 3B is shown. In this implementation, a dental scaling instrument 100 with a pre-die pressed blade 40, comprising a top face 402 and a bottom face 408, is configured to be loaded onto a die-pressing system 20 comprising a top die 20A and a bottom die 20B. In this implementation, the pre-die pressed blade 40 is loaded between the top die 20A and the bottom die 20B. In this implementation, the top die 20A comprises an upper face 23A and a convex face 24A mechanically connected to each other by a body 26A. The convex face 24A comprises a convex protrusion 22A configured to interface with the top face 402 of the pre-die pressed blade 40 to create a depression in the top face 402 to form the depressed top face 402B before the sharpening process (described in FIG. 3D).

In this implementation, the bottom die 20B comprises a lower face 23B and a receptacle face 24B mechanically connected to each other by a body 26B. The receptacle face 24B further comprises a receptacle 22B configured to receive the dental scaling instrument 100 with the pre-die pressed blade 40 such that the bottom face 408 of the pre-die pressed 40 mechanically interfaces with the receptacle 22B. The receptable 22B can be configured to lock the pre-die pressed blade 40 such that the convex protrusion 22A of the top die 20A can apply a downward force to the top face 402 to modify the shape of the top face 402 (e.g., depression) to produce a die-pressed un-sharpened blade 40A with the depressed top face 402B comprising a depression 403 and a bottom face 408B. In some implementations, the top die 20A and the bottom die 20B can be made from a material with a Rockwell Hardness (RC) value of 60 or greater. In some implementations, the top die 20A and bottom die 20B can be made of metal or metal alloy selected from a group including stainless steel and titanium.

Referring to FIG. 3D, a schematic of an exemplary sharpening process of the exemplary blade 400B of FIGS. 3A and 3B is shown. In this exemplary sharpening process, the die pressed un-sharpened blade 40A with the depressed top face 402B and the bottom face 408B is subject to sharpening to form the blade 400B with the depressed top face 402B comprising a depression 403, the bottom face 408B, the at least two side faces 404B where each of the at least two side faces 404B are disposed adjacent to the depressed top face 402B sharing an edge 406B, and a distal tip 410B formed by an intersection of the depressed top face 402B, the at least two side faces 404B, and the bottom face 408B. Initially, before sharpening, the scaling instrument has a numerically greater bevel angle. In this implementation, the depressed top face 402B of the blade 400B comprises a convex profile allowing for a numerically smaller bevel angle α after the sharpening process, where the same amount of material is removed from the at least two sides 404B, in comparison to the blade 400A of the previous iteration of the dental scaling instrument 100. This reduction in the bevel angle α, achieved by the convex profile the top face 402B of the blade 400B, can optimize the cutting efficiency of the instrument and can ensure the structural integrity and strength of the instrument are maintained. In this implementation, the sharpening process achieves a bevel angle α of 60°, a small bevel angle α in comparison with the previous iteration of the dental scaling instrument 100 with the same amount of material removed during the sharpening process.

In this implementation, the bevel angle α can further be altered by changing the convex profile of the top face 402B of the blade 400B with a top die 20A and further removing more material from at least two side faces 404B of the blade 400B. This implementation of the die pressing process and the sharpening process can optimize the bevel angle α sufficiently to reduce the force required for dental calculus removal and can extend the time period of the blade 400B before it requires sharpening. The reduction in bevel angle α can further enhance the performance of the current iteration of the dental scaling instrument 100. By reducing the degree of the bevel angle α, the force required to remove dental calculus by the dental scaling instrument can be significantly lessened and the frequency of sharpening needed by the blade 400B is also significantly reduced. This can result in more efficient, durable, and user-friendly dental scaling instrument 100, offering substantial benefits to dental professionals and their patients.

Referring to the drawings, FIG. 3E shows a cross-sectional view of an exemplary implementation of the blade 400 of a current iteration of the dental scaling instrument 100. In this implementation of the blade 400C as shown in FIG. 3E, the blade 400C comprises a depressed top face 402C comprising a depression 403, with only one of the at least two side faces 404C where one of the at least two side faces 404C is disposed adjacent to the depressed top face 402C sharing an edge 406C, a bottom face 408C contiguous with each of at least two side faces 404C, and a distal tip 410C formed by the intersection of the depressed top face 402C, the at least two side faces 404C, and the bottom face 408C. A bevel angle α of the edge 406C can be measured between the depressed top face 402C and the one adjacent side face of the at least two side faces 404C. In some implementations of the blade 400C, the bevel angle α can be in a range of 20° to 75°. In this implementation of the blade 400C, the bevel angle α is 60°. In this implementation, the bevel angle α is impacted by a combination of the die pressing process (described in FIG. 3C) affecting the shape of the top face 402C and the sharpening process (described in FIG. 3D) only one of the at least two side faces 404C.

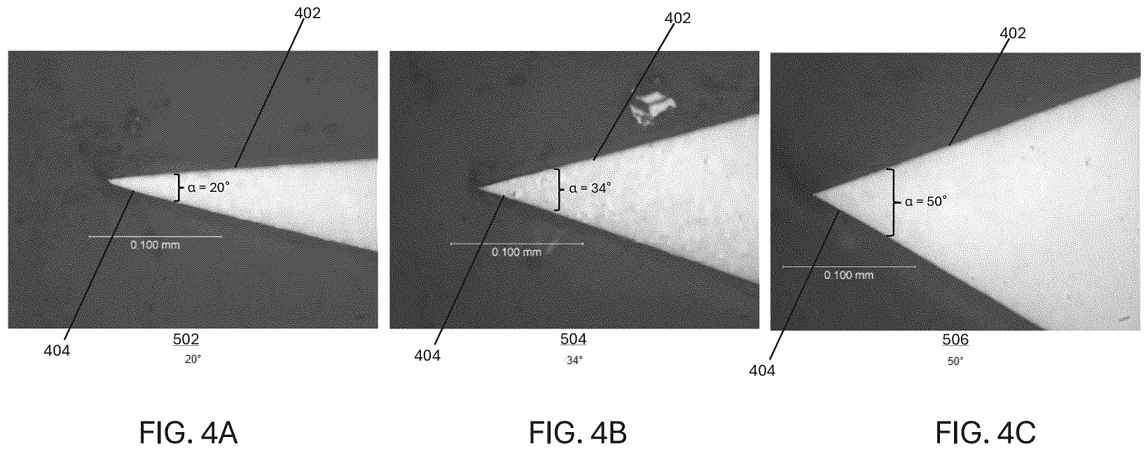

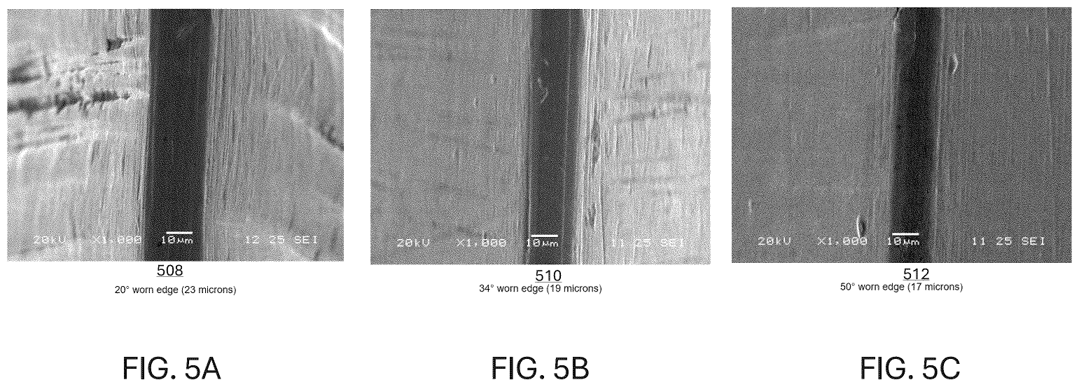

Referring to the drawings, FIGS. 4A-4C show exemplary implementations of three blades 400B with edges 406B each having a different bevel angle α: 200 (FIG. 4A, 502), 340 (FIG. 4B, 504), and 50° (FIG. 4C, 506) before being subject to an edge retention test. In this implementation, the edge retention test used was the cutlery allied trades research association (CATRA) test. The test blades 400B, each comprising a different bevel angle α, were subject to an increasing numbers of cuts while the change in the height of each of the edges 406B were measured with radiographic imaging. For example, FIGS. 5A-5C present exemplary micrographic images of the each of the edges 406B of FIGS. 4A-4C post a fixed number of cuts. FIG. 5A (508) shows a worn edge (decrease in height of the edge 406B) of 23 microns when the bevel angle α is 20°. FIG. 5B (510) shows a worn edge of 19 microns when the bevel angle α is 34°. FIG. 5C (512) shows a worn edge of 17 microns when the bevel angle α is 50°.

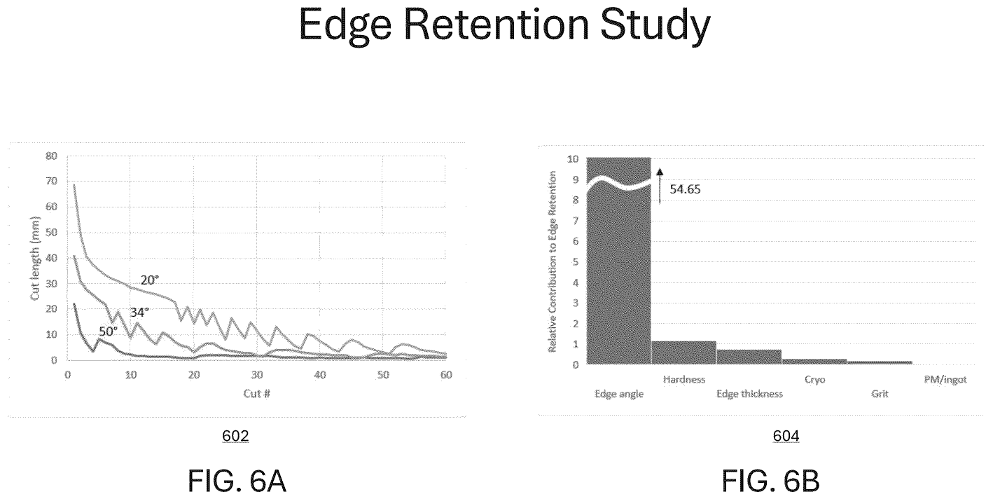

Referring to the drawings, FIG. 6A shows an exemplary line graph 602 of cut length against the number of cuts for bevel angles of 20°, 34°, and 50° as part of the CATRA test. In this exemplary line graph 602, it can be inferred that bevel angle α can be measurable factor to assess edge retention over time.

Referring to the drawings. FIG. 6B shows an exemplary bar graph 604 of relative contribution to edge retention against factors affecting edge retention. Based on the CATRA study, the contribution of the factors affecting edge retention including edge angle (bevel angle), hardness, edge thickness, cryo, grit, and PM/ingot variety were compared. In the bar graph 604 presented in FIG. 6B, it can be inferred that edge angle (bevel angle) contributed most to edge retention compared to the other factors listed above.

While the advantages and preferred implementations of the present invention have been described hereinbefore, those skilled in the art should be understood that the above are merely several illustrative implementations of the present invention without limiting the scope thereof, wherein various modifications, alterations or substitutions may be made to the specific components of the implementations without departing from the spirit and scope of the invention and its claims.

1. A dental scaling instrument comprising:
a handle segment; and
a curved segment mechanically connected to the handle segment, the curved segment comprising:
a support portion configured to connect the handle segment with the curved segment; and
a blade mechanically connected to the support portion, the blade further comprising:
a depressed top face comprising a depression;
at least two side faces wherein at least one of the at least two side faces is disposed adjacent to the top face sharing an edge;
a bottom face contiguous with each of the at least two side faces; and
a distal tip formed by an intersection of the depressed top face, the at least two side faces, and the bottom face,
wherein a bevel angle of the edge between the depressed top face and each of the at least two side faces is in a range of 20° to 75°.

2. The dental scaling instrument of claim 1, wherein the bevel angle is 60°.

3. The dental scaling instrument of claim 1, wherein the handle segment and the curved segment are machined from a single metal piece.

4. The dental scaling instrument of claim 3, wherein the single metal piece is made of metal or metal alloy selected from a group including titanium and stainless steel.

5. The dental scaling instrument of claim 1, wherein the handle segment and the curved segment are connected to each other via:
a threaded extension disposed on the curved segment; and
a complementary threaded received disposed on the handle segment and configured to receive the threaded extension disposed on the curved segment.

6. The dental scaling instrument of claim 1, wherein the distal tip is a rounded distal tip.

7. The dental scaling instrument of claim 1, wherein the handle segment and the curved segment are made of different materials from each other.

8. The dental scaling instrument of claim 1, wherein the blade comprises at least two side faces wherein each of the at least two side faces are disposed adjacent to the top face sharing the edge.

9. A method for manufacturing a dental scaling instrument, the method comprising the steps of:
loading a dental scaling instrument with a pre-die pressed blade onto a die-pressing system comprising a top die and a bottom die, wherein the pre-die pressed blade comprises a top face and a bottom face;
die pressing the pre-die pressed blade with the die-pressing system to create a depression in the top face of the pre-die pressed blade to output a die-pressed un-sharpened blade comprising a depressed top face and a bottom face; and
sharpening the die-pressed pre sharpened blade to output a blade comprising:
a depressed top face comprising a depression;
at least two side faces wherein at least one of the at least two side faces is disposed adjacent to the top face sharing an edge;
a bottom face contiguous with each of the at least two side faces; and
a distal tip formed by an intersection of the depressed top face, the at least two side faces, and the bottom face,
wherein a bevel angle of the edge between the depressed top face and each of the at least two side faces is in a range of 20° to 75°.

10. The method of claim 9, wherein the top die of the die-pressing system comprises:
an upper face;
a convex face; and
a body configured to mechanically connect the upper face and the convex face with each other,
wherein the convex face comprises a convex protrusion configured to interface with the top face of the pre-die pressed blade to create a depression in the top face to form the depressed top face.

11. The method of claim 10, wherein the bottom die of the die-pressing system comprises:
a lower face;
a receptacle face;
a body configured to mechanically connect the lower face and the receptacle face with each other,
wherein the receptacle face comprises a receptacle configured to receive the dental scaling instrument with the pre-die pressed blade such that the bottom face of the pre-die pressed blade mechanically interfaces with the receptacle.

12. The method of claim 11 further comprising the step of:
applying a downward force on the top face of the pre-die pressed blade with convex protrusion of the top die to modify the shape of the top face,
wherein the receptable of the bottom die is configured to lock the pre-die pressed blade when the downward force is applied on the top face.

13. The method of claim 12, wherein the top die and bottom die are made of a metal, or metal alloy selected from a group including stainless steel and titanium.

14. The method of claim 9, wherein the bevel angle of the edge is altered by removing material from at least one of the at least two side faces via the sharpening process.

15. The method of claim 14, wherein the bevel angle is 60°.

16. The method of claim 9, wherein the sharpening the die-pressed pre sharpened blade to output a blade comprising at least two side faces wherein each of at least two side faces are disposed adjacent to the top face sharing the edge.
